(19) United States
(12) Patent Application Publication
(10) Pub. No.: US 2019/0318305 A1
(43) Pub. Date: Oct. 17, 2019

(54) INVENTORY REPLENISHMENT SYSTEM, METHOD, AND DEVICE

(71) Applicant: Fullfill Systems LLC, Milwaukee, WI (US)

(72) Inventor: Aleks Nikolich, SHOREWOOD, WI (US)

(73) Assignee: Fullfill Systems LLC, Milwaukee, WI (US)

(21) Appl. No.: 16/447,255

(22) Filed: Jun. 20, 2019

Related U.S. Application Data
(63) Continuation-in-part of application No. 16/252,270, filed on Jan. 18, 2019.
(60) Provisional application No. 62/624,011, filed on Jan. 30, 2018.

(51) Int. Cl. G06Q 10/08; G07F 11/44

(52) U.S. Cl. CPC G06Q 10/087; G07F 11/60; G07F 11/44

(57) ABSTRACT

An inventory replenishment device may optionally include a barrier wall positioned between a first support surface of an inventory management apparatus and a second support surface of the inventory management apparatus, the barrier wall forming a barrier between the first support surface and the second support surface. A divider may be movably coupled to the barrier wall via an articulation joint. The articulation joint may be configured to enable the divider to be moved between a first position and a second position, the divider blocking access to the first quantity of inventory items when the divider is in the first position, and the divider blocking access to the second quantity of inventory items when the divider is in the second position. Optionally, an auxiliary divider may be movably coupled to the divider, and the auxiliary divider may be movable between a first and second orientation.

### CROSS REFERENCE TO RELATED APPLICATIONS

This application is a continuation-in-part of U.S. Non-Provisional application Ser. No. 16/252,270, filed on Jan. 18, 2019, entitled “INVENTORY REPLENISHMENT SYSTEM, METHOD, AND DEVICE”, which claims the benefit of U.S. Provisional Patent Application Ser. No. 62/624,011, filed on Jan. 30, 2018, entitled “NOVEL METHOD AND SYSTEM FOR AUTOMATED REPLENISHMENT OF REMOTE AND DEPARTMENTAL INVENTORY”, the entire disclosures of which are incorporated by reference herein.

### FIELD OF THE INVENTION

This patent specification relates to the field of devices and methods for the management and replenishment of articles or supplies. More specifically, this patent specification relates to devices and methods that are configured to physically block access to one or more articles or supplies and to electronically communicate when the one or more articles or supplies are accessed for inventory management and replenishment.

### BACKGROUND

Businesses, such as hospitals, offices, and manufacturing plants, involve the use of supplies for their day to day activities. Examples of articles or supplies are pens and pencils in offices, bandages and syringes in hospitals, and paint in automotive repair shops. As businesses grow and increase in size, it becomes necessary to provide these supplies near the areas of activity to improve the efficiency of their operations. This is typically accomplished by providing carts or storage solutions that are stocked with often-used supplies and placing them near the areas of activity or point-of-use. This results in diminishing the need to travel to and from a warehouse, distributor or retailer.

As supplies are used up at their point-of-use, it is necessary to replenish those supplies from a warehouse, distributor or retailer to the point-of-use. Two commonly used methods for inventory replenishment are individual article counts with maximum and reorder levels (i.e. PAR) and aggregated article counts where levels are either full, reorder, or empty (i.e. Kanban).

Another challenge for managing point-of-use inventory is that many organizations utilize just-in-time principles for managing their inventory. In this scenario, there is very little or no centralized inventory in the facility. When inventory is depleted in a department, the person requiring the supply or article must wander around the facility in search of the supply or article, leading to great inefficiencies.

As an overall process of distributing supplies, point-of-use storage solutions used together with a warehouse, distributor or retailer have been used, but they have not been completely successful, and the point-of-use storage solutions and use thereof in the present invention provide great advantages over the arrangement of that phase known heretofore. The supplies of articles and their distribution heretofore required manual counts of the articles and further manual manipulations for entering various data into the system which included running tabulations of the articles to be distributed.

Moreover, point-of-use storage solutions heretofore used have been of the kind known as closed cabinets similar to vending machines, that unlock a door or dispense a supply when the proper data is entered into its computer. These solutions are bulky, expensive and require multiple steps by the user to access the supply.

Furthermore, just-in-time inventory systems have greatly reduced the amount of inventory stored within a facility. Whereas in the past, a facility might have a central warehouse with an ample amount of supplies, the current facility only has inventory stored at the point-of-use.

Therefore, a need exists in the field for novel methods and devices capable of capturing inventory levels for the replenishment of point-of-use inventory stored in open storage solutions, communicating from the point-of-use to a central warehouse, distributor or retailer the amount of supply that needs to be replenished, and providing the user with nearby locations within their facility that have the supply they require when that supply is stocked out at their current point-of-use.

### BRIEF SUMMARY OF THE INVENTION

According to one embodiment consistent with the principles of the invention, an inventory replenishment device is provided. In some embodiments, the device may optionally include a barrier wall positioned between a first support surface of an inventory management apparatus and a second support surface of the inventory management apparatus, the barrier wall forming a fixed barrier between the first support surface and the second support surface. The inventory management apparatus may be adapted to hold a plurality of inventory items segregated into a first quantity of inventory items supported on the first support surface and being located on a first side of the barrier wall and a second quantity of inventory items supported on the second support surface and being located on an opposing second side of the barrier wall. A divider may be movably coupled to the barrier wall via an articulation joint. A divider blocks or otherwise prevents access to inventory items located on a side of the barrier wall and must be moved in order to gain access to the inventory items. The articulation joint may be configured to enable the divider to be moved between a first position and a second position, the divider blocking access to the first quantity of inventory items when the divider is in the first position, and the divider blocking access to the second quantity of inventory items when the divider is in the second position.

In further embodiments, the device may include an actuation sensor which may be configured to detect when the divider is moved between the first position and the second position and further configured to output an electronic signal when the divider is moved between the first position and the second position.

In further embodiments, the device may include an auxiliary divider that may be movably coupled to the divider. Preferably, the auxiliary divider may have a first side and a second side, and the auxiliary divider moves between a first orientation and a second orientation when the divider is moved from a first position to a second position. In further embodiments, the first side of the auxiliary divider may face away from the inventory management apparatus when the divider is in the first position, and the second side of the auxiliary divider may face away from the inventory management apparatus when the divider is in the second position.

In yet further embodiments, the device may include a divider which may be coupled to an inventory management apparatus via an articulation joint. The inventory management apparatus may be used to hold or support one or more inventory items, and the divider may be coupled to the inventory management apparatus so that two or more inventory items may be separated by the divider. The articulation joint may enable the divider to be moved between a first position, in which the divider may block access of one or more inventory items, and a second position, in which the divider may allow access of the one or more inventory items. An actuation sensor may be configured to detect when the divider is moved into the second position, and the actuation sensor may be configured to output an electronic signal to a client device when the divider is moved into the second position.

In yet further embodiments, the device may include an articulation joint configured to be coupled to an inventory management apparatus, the inventory management apparatus adapted to hold a plurality of inventory items that are segregated into a first quantity of inventory items and a second quantity of inventory items, the first quantity of inventory items being located at a first storage area on one side of the articulation joint within the inventory management apparatus and the second quantity of inventory items being located at a second storage area on an opposite side of the articulation joint within the inventory management apparatus. A divider may be pivotally coupled to the articulation joint, in which the articulation joint is configured to enable the divider to be moved between a first position and a second position, the divider blocking access to one of the first and second quantities of the inventory items when the divider is in the first position. An actuation sensor may be coupled to a divider surface of the divider, the actuation sensor configured to detect when the divider is moved into the second position and configured to output an electronic signal when the divider is moved into the second position.

According to another embodiment consistent with the principles of the invention, an inventory replenishment system is provided. In some embodiments, the system may comprise an inventory management apparatus and an inventory data management module which may comprise or function as management logic and which may be executable by a processor a client device and/or server. The inventory data management module may be configured to generate a replenishment order for the first and second inventory items in response to the electronic signal and to preferably send the replenishment order to a third-party server via a network.

According to another embodiment consistent with the principles of the invention, a computer implemented method for inventory replenishment is provided. In some embodiments, the method may include the steps of: providing an inventory replenishment device, the device including: a divider configured to be movably coupled to an inventory management apparatus so that the divider is movable between a first position and a second position; positioning a first inventory item and a second inventory item on a support surface of the inventory management apparatus, in which the first inventory item and the second inventory item are positioned on opposite sides of the divider, and in which the divider blocks access to the second inventory item when the divider is in the first position; providing an actuation sensor mounted onto the divider and being operable to detect movement of the divider without a positional reference external to the actuation sensor and to broadcast an electronic signal upon detecting movement of the divider; and communicating the electronic signal from the actuation sensor to an inventory data management module comprising a user interface, the inventory data management module facilitating the administration of the inventory item.

According to another embodiment consistent with the principles of the invention, an inventory replenishment system is provided. In some embodiments, the system may include a divider having a divider aperture, the divider aperture configured to temporarily receive a rod-shaped inventory management apparatus suitable for hanging inventory items from the rod-shaped inventory management apparatus. An actuation sensor may be mounted to the divider, and the actuation sensor may be configured to detect movement of the divider and to send an electronic signal to an inventory data management module.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an inventory replenishment device according to various embodiments described herein.

FIG. 2 illustrates a perspective view of another example of an inventory replenishment device having a divider in a first position according to various embodiments described herein.

FIG. 3 a perspective view of an example of another inventory replenishment device having a divider in a second position according to various embodiments described herein.

FIG. 4 depicts a perspective view of yet another example of an inventory replenishment device having a divider in a first position according to various embodiments described herein.

FIG. 5 illustrates a perspective view of yet another example of an inventory replenishment device having a divider in a second position according to various embodiments described herein.

FIG. 6 shows a perspective view of still another example of another inventory replenishment device having a divider in a first position according to various embodiments described herein.

FIG. 7 depicts a perspective view of still another example of another inventory replenishment device having a divider in a second position according to various embodiments described herein.

FIG. 8 illustrates a perspective view of a further example of another inventory replenishment device having a divider in a first position according to various embodiments described herein.

FIG. 9 shows a perspective view of a further example of another inventory replenishment device having a divider in a second position according to various embodiments described herein.

FIG. 10 depicts an example of still a further perspective view of an example of another inventory replenishment device having a divider in a first position according to various embodiments described herein.

FIG. 11 illustrates a perspective view of still a further example of another inventory replenishment device having a divider in a second position according to various embodiments described herein.

FIG. 12 shows a perspective view of yet a further example of another inventory replenishment device having a divider in a first position according to various embodiments described herein.

FIG. 13 depicts an illustrative example of some of the components and computer implemented methods which may be found in an inventory replenishment system according to various embodiments described herein.

FIG. 14 illustrates a block diagram showing an example of a server which may be used by the system as described in various embodiments herein.

FIG. 15 shows a block diagram illustrating an example of a client device which may be used by the system as described in various embodiments herein.

FIG. 16 depicts a block diagram illustrating an example of an inventory replenishment device that comprises a client device which may be used by the system as described in various embodiments herein.

FIG. 17 illustrates a block diagram of an example of a computer-implemented method for determining and generating an electronic observation to a user according to various embodiments described herein.

FIG. 18 shows a rear perspective view of still yet a further example of another inventory replenishment device having a divider in a first position and having a magnet coupled to an exterior sidewall surface according to various embodiments described herein.

FIG. 19A depicts a front elevation view of another example of an inventory replenishment device having a divider in a first position according to various embodiments described herein.

FIG. 19B illustrates a front elevation view of another example of an inventory replenishment device having a divider being moved between a first position and a second position according to various embodiments described herein.

FIG. 19C shows a front elevation view of another example of an inventory replenishment device having a divider in a second position according to various embodiments described herein.

FIG. 20A depicts a perspective view of yet another example of an inventory replenishment device having a divider in a first position according to various embodiments described herein.

FIG. 20B illustrates a perspective view of yet another example of an inventory replenishment device having a divider being moved between a first position and a second position according to various embodiments described herein.

FIG. 20C shows a perspective view of yet another example of an inventory replenishment device having a divider in a second position according to various embodiments described herein.

FIG. 21A depicts a perspective view of still another example of an inventory replenishment device having a divider in a first position according to various embodiments described herein.

FIG. 21B illustrates a perspective view of still another example of an inventory replenishment device having a divider in a second position according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoW) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

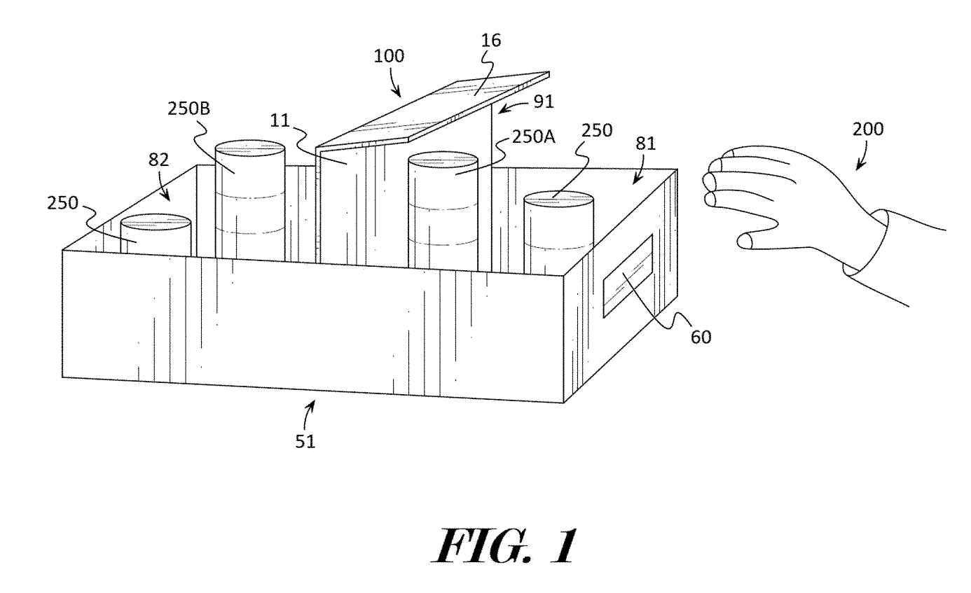

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

New devices and methods for the management and replenishment of articles or supplies are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIGS. 1-12 illustrate examples of an inventory replenishment device (“the device”) 100 according to various embodiments. In some embodiments, the device 100 may comprise a divider 11 which may be coupled to an inventory management apparatus 51 via an articulation joint 12. The inventory management apparatus 51 may be used to hold or support one or more inventory items 250, and the divider 11 may be coupled to the inventory management apparatus 51 so that two or more inventory items 250 may be separated by the divider 11. The articulation joint 12 may be configured to enable the divider 11 to be moved between a first position 91, in which the divider 11 may block access of one or more inventory items 250, and a second position 92, in which the divider 11 may allow access of the one or more inventory items 250. An actuation sensor 13 may be configured to detect when the divider 11 is moved into the second position 91, and the actuation sensor 13 may be configured to output an electronic signal 95 when the divider 11 is moved into the second position 92. In preferred embodiments, an electronic signal 95 may comprise a radio frequency (RF) electronic signal.

An inventory management apparatus 51 may comprise any object which may be used to hold, support, contain, etc., one or more inventory items 250 in a manner that may enable the inventory items 250 to be accessible to a user 200. Inventory items 250 may be held, supported, contained, placed on a first support surface 52 and a second support surface 53 of an inventory management apparatus 51 with the divider 11 separating or forming a physical barrier between the first support surface 52 and the second support surface 53. Optionally, a 51 may comprise one or more sidewalls 54, 55, 56, 57, which may be coupled to or proximate to a 52 and/or a 53. One or more optional sidewalls 54, 55, 56, 57, may extend above the support surfaces 52, 53, so that they may be used to contain inventory items 250 that are placed on the support surfaces 52, 53. Support surfaces 52, 53, and optional sidewalls 54, 55, 56, 57, may be configured in any shape and size to allow the 51 to hold, support, contain, etc., one or more inventory items 250.

An inventory replenishment device 51 may comprise one or more interior sidewall surfaces 71 and exterior sidewall surfaces 72 which may be formed by or on one or more sidewalls 54, 55, 56, 57. Generally, the interior sidewall surfaces 71 may form portions of the first storage area 81 and second storage area 82 of the inventory replenishment device 51 which may allow the inventory replenishment device 51 to hold a plurality of inventory items 250. The exterior sidewall surfaces 72 which may be formed by or on one or more sidewalls 54, 55, 56, 57, and opposingly positioned on the sidewalls 54, 55, 56, 57, to the interior sidewall surfaces 71 so that the exterior sidewall surfaces 72 may form the exterior surfaces of the inventory replenishment device 51.

Preferably, an inventory management apparatus 51 may comprise a label 60 and/or be configured to receive or couple a label 60 which may contain information, such as information that may describe the items 250 of the inventory management apparatus 51 and information that may be used to restock or resupply the inventory management apparatus 51. Preferably, a label 60 may be received or coupled to an exterior sidewall surface 72.

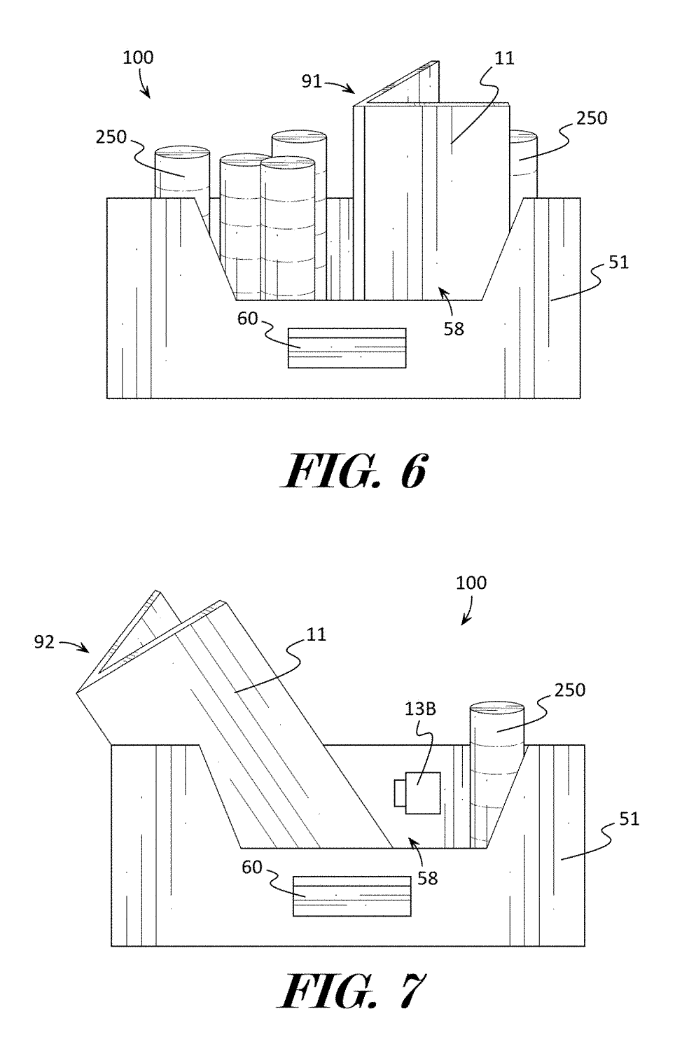

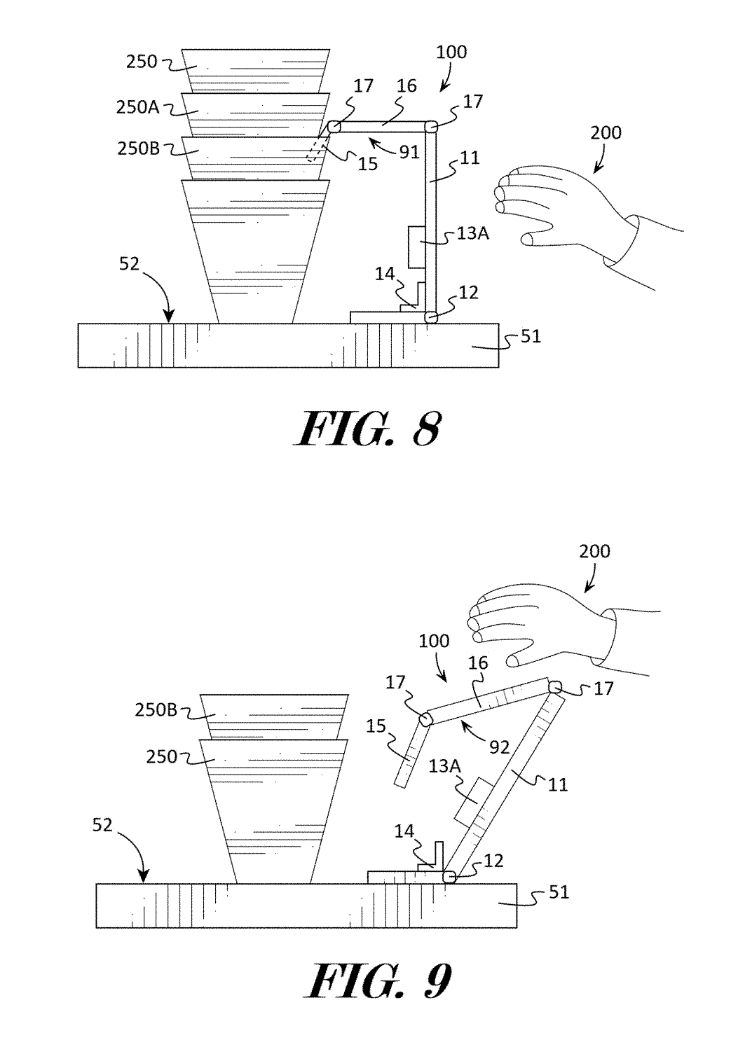

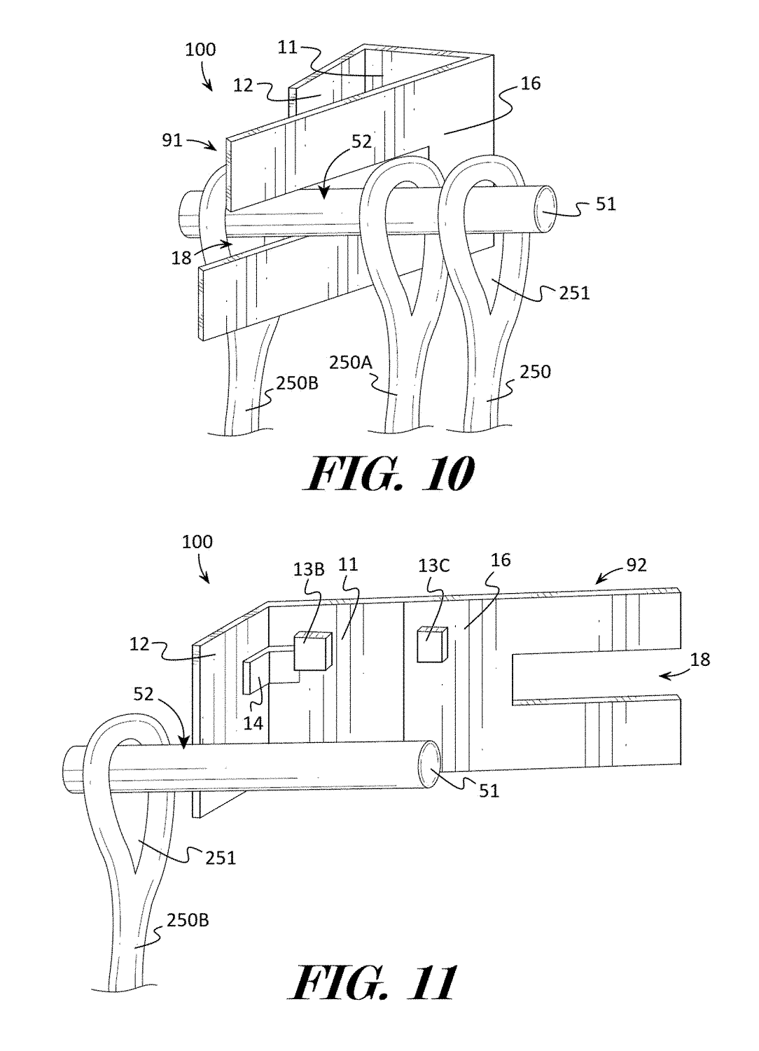

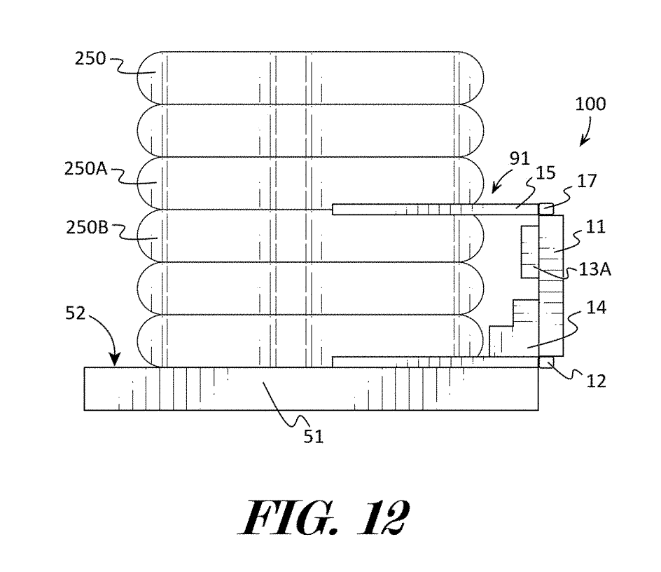

Inventory items 250 may comprise any object which may be held, supported, contained, placed etc. on a support surface 52, 53, of an inventory management apparatus 51 typically used for stocking and restocking purposes. For example, an inventory management apparatus 51 may comprise a storage bin and the inventory items 250 may include gauze pad packages similar to the example of FIGS. 6 and 7. As another example, an inventory management apparatus 51 may comprise a shelf and the inventory items 250 may include disposable cups similar to the example of FIGS. 8 and 9. As a further example, an inventory management apparatus 51 may comprise a hanging peg and the inventory items 250 may include spoons having hanging apertures similar to the example of FIGS. 10 and 11. As still another example, an inventory management apparatus 51 may comprise a shelf and the inventory items 250 may include folded towels similar to the example of FIG. 12.

An inventory management apparatus 51 may be adapted to hold a plurality of inventory items 250 that are segregated into a first quantity of inventory items and a second quantity of inventory items by the divider 11 and/or articulation joint 12. Generally, the device 100 may be configured to divide an inventory management apparatus 51 into two portions, such as a first storage area 81 and a second storage area 82, so that inventory items 250 contained or positioned in the first storage area 81 may be freely accessible to a user 200 while access to the inventory items 250 in the second storage area 82 may be governed by the divider 11. Inventory items 250 held, supported, contained, placed etc. on the first support surface 52 may be considered to be in the first storage area 81 of the inventory management apparatus 51, while inventory items 250 held, supported, contained, placed etc. on the second support surface 53 may be considered to be in the second storage area 82 of the inventory management apparatus 51. In some embodiments, the device 100 may be configured to be coupled to an inventory management apparatus 51 so that the device 100 may be retrofitted to existing inventory management apparatuses 51. In other embodiments, the device 100 may comprise an inventory management apparatus 51.

A divider 11 may be configured in any size and shape which may allow the divider to govern access to inventory items 250 held, supported, contained, placed etc. on the second support surface 53 of an inventory management apparatus 51. In this manner, the divider 11 may be configured to block access to one or more, such as a quantity of inventory items 250 in or on the second storage area 82 of the inventory management apparatus 51 when the divider 11 is in the first position 91. In its simplest form a divider may comprise a generally rectangular shaped wall that may extend up away from the support surfaces 52, 53, of an inventory management apparatus 51 as shown by the examples of FIGS. 1-5. Preferably, a divider 11 may be made from or may comprise a substantially rigid material, including wood, cardboard, plastics, such as polyethylene (PE), Ultra-high-molecular-weight polyethylene (UHMWPE, UHMW), polypropylene (PP) and polyvinyl chloride (PVC), polycarbonate, metals and metal alloys, or any other substantially rigid material which may be suitable for dividing an inventory management apparatus 51 into two or more storage areas 81, 82. Optionally, a divider 11 may be made from or may comprise a transparent or translucent material or a divider 11 may be may be made from or may comprise a generally opaque material.

The device 100 may comprise one or more articulation joints 12 which may be used to movably couple a divider 11 to an inventory management apparatus 51 so that the divider 11 may be moved between a first position 91 and a second position 92. An articulation joint 12 may be coupled to an inventory management apparatus 51 with adhesive, with fasteners, such as threaded fasteners and hook and loop type fasteners, with heat bonding or welding, or any other suitable coupling method which may enable an articulation joint 12 to remain coupled to an inventory management apparatus 51 while the divider 11 is moved between a first 91 and second 92 position.

In preferred embodiments, an articulation joint 12 may comprise a hinge, such as a butt hinge, butterfly hinge, flush hinge, barrel hinge, concealed hinge, continuous hinge, T-hinge, strap hinge, double-acting hinge, Soss hinge, a flexible material hinge, or any other type or style of hinge or pivotal joining method that allows portions of a divider 11 to be pivoted relative to an inventory management apparatus 51. In further embodiments, an articulation joint 12 may comprise any type of hinge known in the art, including so-called “living” hinges, which typically comprise a linear, relatively flexible area between two relatively more rigid components, such as a line of thin plastic between thicker plastic portions, as is well known in the art. In further embodiments, an articulation joint 12 may comprise a spring or other tension providing device that is able to mechanically assist with maintaining the divider 11 in the first position 91 and/or the second position 92. In other embodiments, an articulation joint 12 may slidably join or couple a divider 11 to an inventory management apparatus 51 with a tongue and groove engagement allowing portions of a divider 11 to be moved by being slid between the first position 91 and/or the second position 92. Another example would be a sliding divider 11 where the articulation joint 12 comprises a slide track that enables the sliding movement of the divider 11 between the first position 91 and the second position 92. In further embodiments, an articulation joint 12 may be configured as any other type of engagement that allows a divider 11 to be moved between the first position 91 and/or the second position 92.

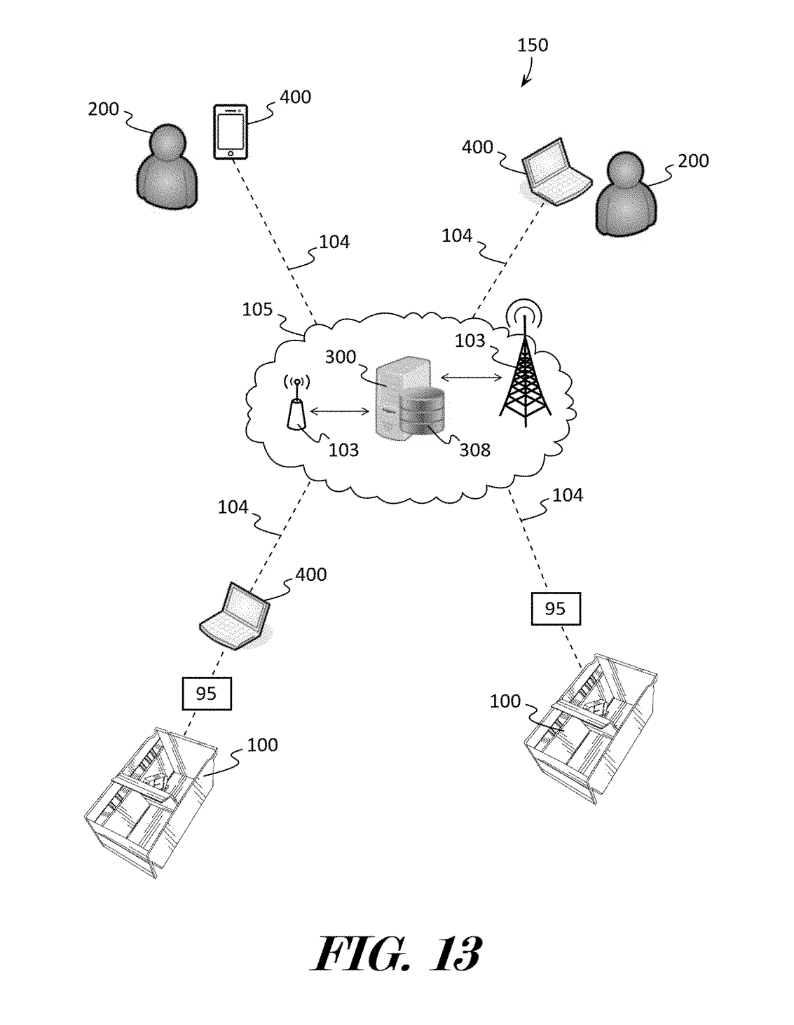

The device 100 may comprise one or more actuation sensors 13 which may be configured to detect when the divider 11 is moved into the second position 92, and the actuation sensor 13 may also be configured to output an electronic signal 95 when the divider 11 is moved into the second position 92. In preferred embodiments, the actuation sensor 13 may be in wireless, such as by having a radio similar to a radio 406 of a client device 400, or wired communication with a client device 400 (FIGS. 13, 15, and 16), and the actuation sensor 13 may output a wireless electronic signal 95, such as a radio frequency (RF) electronic signal, or a wired electronic signal 95 to the client device 400. In further preferred embodiments, an actuation sensor 13 may be coupled to the divider 11, such as to a divider surface 19 of the divider 11.

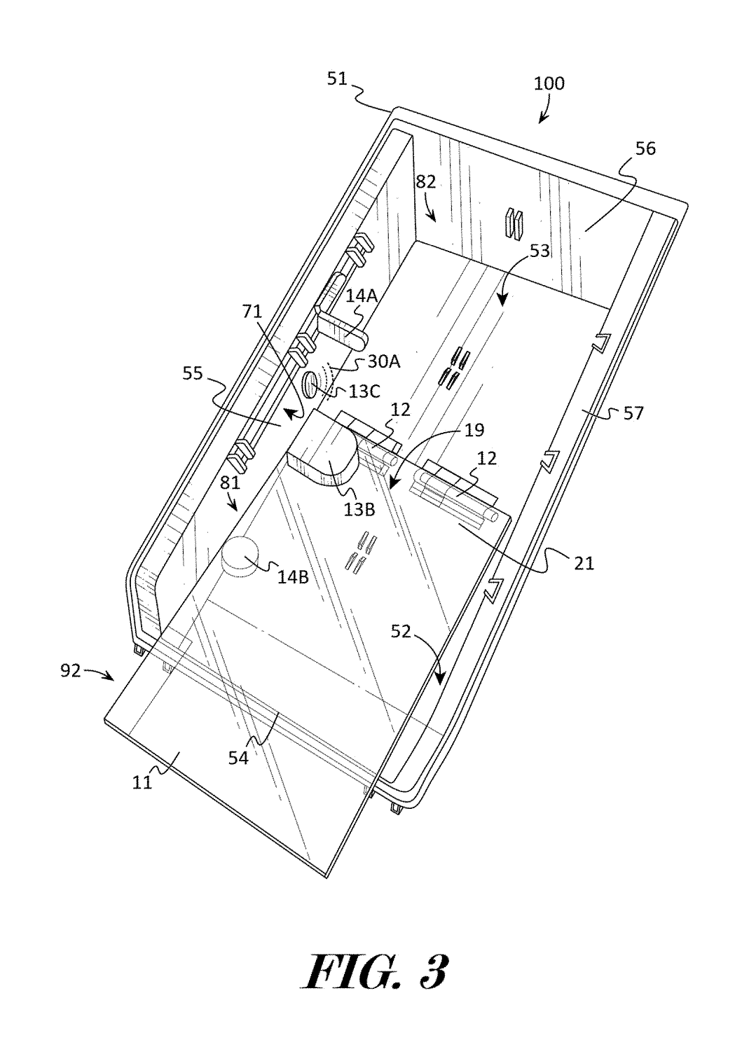

In some embodiments, and as shown in FIG. 3, the device 100 may comprise a magnet 13C coupled to an interior sidewall surface 71, and the actuation sensor 13 may be adapted to detect an internal magnetic field 30A of the magnet 13C that is coupled to the interior sidewall surface 71. In further embodiments, and as shown in FIG. 18, the device 100 may comprise a magnet 13C coupled to an exterior sidewall surface 72, and the actuation sensor 13 may be adapted to detect an external magnetic field 30B of the magnet 13C coupled to the exterior sidewall surface 72. An internal magnetic field 30A may comprise a magnetic field 30 generated by a magnet 13C that is positioned within the inventory management apparatus 51, while an external magnetic field 30A may comprise a magnetic field 30 generated by a magnet 13C that is positioned outside or external to the inventory management apparatus 51 so that the magnetic field must pass through an interior sidewall surface 71 and/or an exterior sidewall surface 72.

In some embodiments, an actuation sensor 13 may comprise or may be a tilt sensor 13A. In further embodiments, an actuation sensor 13 may be a tilt sensor 13A and may be configured to measure the angle of the divider 11 relative to a first support surface 52 of the inventory management apparatus 51. In preferred embodiments, a tilt sensor 13A may comprise any sensor that may detect inertial motion without the use of an external reference position. For example, a tilt sensor 13A may comprise an inclinometer or clinometer which is an instrument used for measuring angles of slope (or tilt), elevation, or depression of an object with respect to gravity's direction. It is also known as a tilt indicator, tilt sensor, tilt meter, slope alert, slope gauge, gradient meter, gradiometer, level gauge, level meter, declinometer, and pitch & roll indicator. For example, a tilt sensor 13A may be configured as or may comprise an accelerometer which may measure tilt angle of a divider 11 with reference to the earth's ground plane to determine when the divider 11 is in the second position 92.

In other embodiments, an actuation sensor 13 may comprise or may be a hall effect sensor 13B. A hall effect sensor 13B may generally be described as a transducer that varies its output voltage in response to a magnetic field. Hall effect sensors are used for proximity switching, positioning, speed detection, and current sensing applications. In its simplest form, the sensor operates as an analog transducer, directly returning a voltage. With a known magnetic field, its distance from the Hall plate can be determined. In preferred embodiments, a hall effect sensor 13B may detect the presence of a magnetic object when the divider 11 is in the first position 91 or the second position 92, and/or to conversely detect the absence of the magnetic object to determine if the is in the first position 91 or the second position 92. In further preferred embodiments, a hall effect sensor 13B may be configured to detect a magnetic field from a magnet 13C in which the magnet 13B may be spaced laterally apart from the divider 11 and positioned external to a base of the divider 21.

In further embodiments, an actuation sensor 13 may comprise a hall effect sensor 13B configured to detect a magnetic field, such as an internal magnetic field 30A and/or an external magnetic field 30B, from a magnet 13C, the magnet 13C spaced laterally apart from the divider 11 and positioned external to a base 21 of the divider 11. A laterally spaced magnet 13C may generally describe a magnet 13C positioned to the right (proximate to or in contact with a sidewall 55) or left (proximate to or in contact with a sidewall 57) of the divider 11 and articulation joint 12 (so as not to be in contact with the divider 11 or articulation joint 12) as opposed to being positioned above or below (and optionally in contact with the divider 11 or articulation joint 12) the articulation joint 12 and divider 11 (an optionally proximate to or in contact with a support surface 52, divider 11, or articulation joint 12). In preferred embodiments, a magnet 13C may be positioned separate from the divider 11, including the base of the divider 21, and from the articulation joint 12.

In alternative embodiments, a actuation sensor 13 may comprise a detent switch, single pole switch, electric eye, pressure switch, electrical circuit, a reed switch, a contact sensor, a button mount, an ambient light sensor, Capacitive transducer, Capacitive displacement sensor, Eddy-current sensor, Ultrasonic sensor, Grating sensor, Inductive non-contact position sensors, Laser Doppler Vibrometer (optical), Linear variable differential transformer (LVDT), Multi-axis displacement transducer, Photodiode array, Piezo-electric transducer (piezo-electric), Potentiometer, Proximity sensor (optical), Rotary encoder (angular), Seismic displacement pick-up, String potentiometer (also known as string pot., string encoder, cable position transducer), or any other suitable sensor that may be configured to detect the movement of a divider 11 into the second position 92 and/or to detect the divider 11 in the second position 92.

Optionally, the device 100 may comprise a retainer 14 which may be configured to support or maintain the divider 11 in the first position 91 or the second position 92. In some embodiments, a retainer 14 may comprise a tab, protrusion, or other structural object which may be coupled to a portion of the inventory management apparatus 51, such as to a support surface 52, 53, and/or a sidewall 54, 55, 56, 57, which the divider 11 may rest against while in the first position 91. In preferred embodiments, a retainer 14 may comprise a first magnetic element 14A and a second magnetic element 14B. One of the magnetic elements 14A, 14B, may be coupled to the divider 11 and the other magnetic element 14A, 14B, may be coupled directly or indirectly to the inventory management apparatus 51. The magnetic elements 14A, 14B, may be magnetically engaged together and positioned so that they may be magnetically engaged together when the divider 11 is in the first position 91. In this manner, the divider 11 may be supported in the first position 91 by a magnetic engagement between the first magnetic element 14A and the second magnetic element 14B. The magnetic engagement between the magnetic elements 14A, 14B, may prevent the divider 11 from inadvertently being moved out of the first position 91.

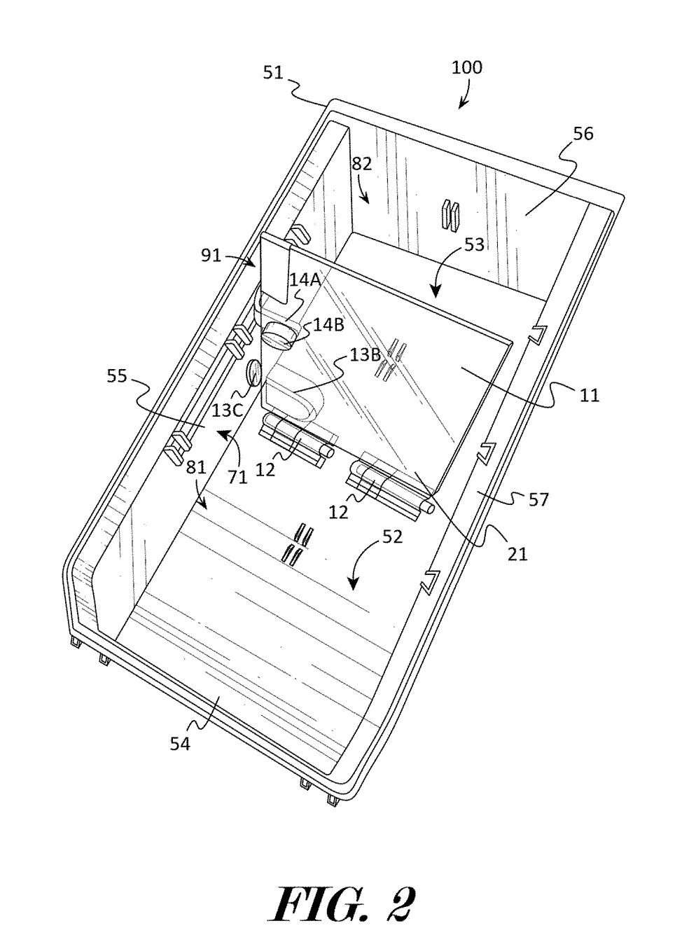

Turning now to FIGS. 2 and 3, an example of a device 100 is illustrated. The device 100 may comprise an inventory management apparatus 51 or the device 100 may be coupled to an inventory management apparatus 51. In this example, the inventory management apparatus 51 comprises a first support surface 52 and a second support surface 53 that are separated by a divider 11 that is movably coupled to the inventory management apparatus 51 via a hinge type articulation joint 12. The inventory management apparatus 51 also comprises four sidewalls 54, 55, 56, 57, that extend above the support surfaces 52, 53, which may be used to contain inventory items 250 that are placed on the support surfaces 52, 53. The inventory management apparatus 51 also includes an access area 58 through which a user 200 may reach into the inventory management apparatus 51 in order to add and remove inventory items 250. When the divider 11 is in the first position 91 (FIG. 2), the divider 11 may generally prevent the user 200 from reaching through the access area 58 and into the second storage area 82. By moving the divider 11 into the second position 92 (FIG. 3), access to the second storage area 82 and the inventory items 250 contained therein may be granted. In this example, the actuation sensor 13 comprises a hall effect sensor 13B that generates an electronic signal 95 when it is moved away from a magnet 13C as the divider 11 is moved or placed in the second position 92. Additionally, a first magnetic element 14A is coupled to the divider 11 and a second magnetic element 14B is coupled to the inventory management apparatus 51, and the divider 11 may be supported in the first position 91 by a magnetic engagement between the first magnetic element 14A and the second magnetic element 14B as shown in FIG. 2.

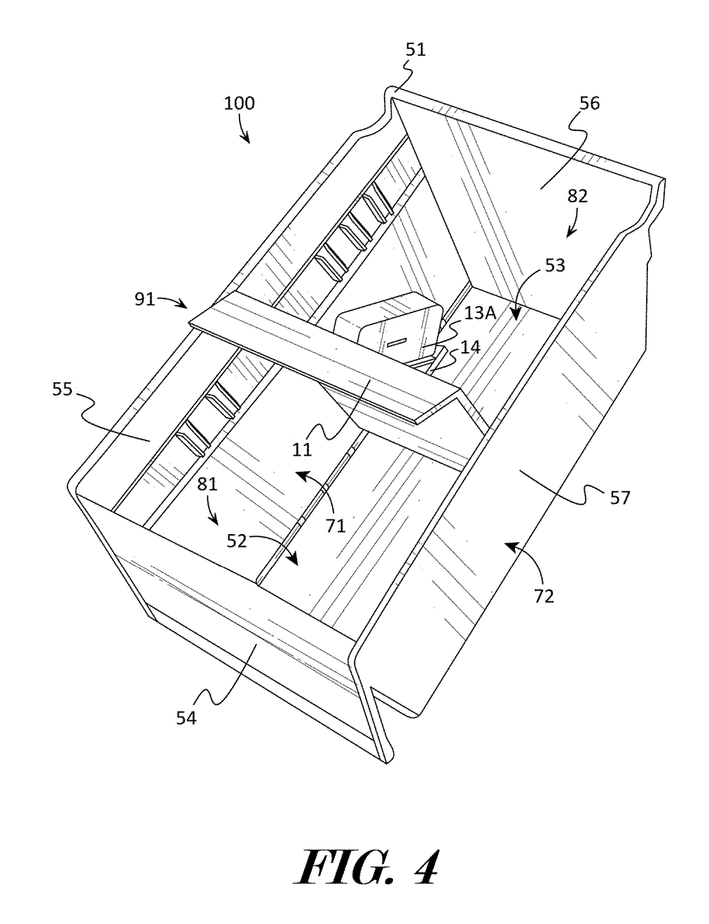

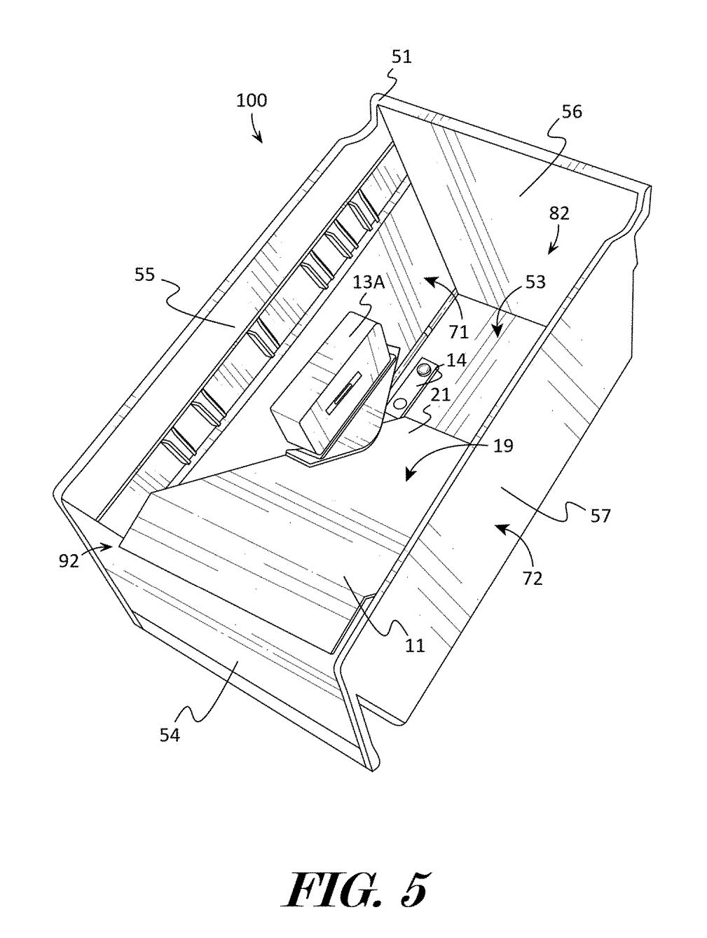

Referring to FIGS. 4 and 5, another example of a device 100 is illustrated. The device 100 may comprise an inventory management apparatus 51 or the device 100 may be coupled to an inventory management apparatus 51. In this example, the inventory management apparatus 51 comprises a first support surface 52 and a second support surface 53 that are separated by a divider 11 that is movably coupled to the inventory management apparatus 51 via a living hinge type articulation joint 12. The inventory management apparatus 51 also comprises four sidewalls 54, 55, 56, 57, that extend above the support surfaces 52, 53, which may be used to contain inventory items 250 that are placed on the support surfaces 52, 53. The inventory management apparatus 51 also includes an access area 58 through which a user 200 may reach into the inventory management apparatus 51 in order to add and remove inventory items 250. When the divider 11 is in the first position 91 (FIG. 4), the divider 11 may generally prevent the user 200 from reaching through the access area 58 and into the second storage area 82. By moving the divider 11 into the second position 92 (FIG. 5), access to the second storage area 82 and the inventory items 250 contained therein may be granted. In this example, the actuation sensor 13 comprises a tilt sensor that generates an electronic signal 95 when it is tilted towards the second storage area 82 as the divider 11 is moved or placed in the second position 92. Additionally, a first magnetic element 14A is coupled to the actuation sensor 13 and a second magnetic element 14B is coupled to the second support surface 53, and the divider 11 may be supported in the first position 91 by a magnetic engagement between the first magnetic element 14A and the second magnetic element 14B as shown in FIG. 4.

Referring to FIGS. 6 and 7, another example of a device 100 is illustrated. The device 100 may comprise an inventory management apparatus 51 or the device 100 may be coupled to an inventory management apparatus 51. In this example, the inventory management apparatus 51 comprises a first support surface 52 and a 53 that are separated by a divider 11 that is movably coupled to the inventory management apparatus 51. The inventory management apparatus 51 also comprises four sidewalls 54, 55, 56, 57, that extend above the support surfaces 52, 53, which may be used to contain inventory items 250 that are placed on the support surfaces 52, 53. The inventory management apparatus 51 also includes an access area 58 through which a user 200 may reach into the inventory management apparatus 51 in order to add and remove inventory items 250. A divider 11 may be moved in any direction to be moved between a first position 91 and a second position 92, and in this example the divider 11 is moved side to side in order to be moved between a first position 91 and second position 92 as opposed to being moved forwards and backwards as shown in the examples of FIGS. 2-5. When the divider 11 is in the first position 91 (FIG. 6), the divider 11 may generally prevent the user 200 from reaching through the right side of the 58 and into the second storage area 82. By moving the divider 11 to the left and into the second position 92 (FIG. 7), access to the second storage area 82 and the inventory items 250 contained therein may be granted. In this example, the actuation sensor 13 comprises a hall effect sensor that generates an electronic signal 95 when the divider 11 is moved towards the second storage area 82 as the divider 11 is moved or placed in the second position 92.

In some embodiments, a divider 11 may comprise one or more nesting tabs 15. Generally, a nesting tab 15 may comprise a structure that may be inserted or positioned between two adjacent inventory items 250A, 250B. For example, a nesting tab 15 may be disposed or positioned between a first adjacent inventory item 250A and a second adjacent inventory item 250B to separate stacked or nested items 250A, 250B, as shown in FIGS. 8-12. Adjacent inventory items 250A, 250B, may comprise a first adjacent inventory item 250A and a second inventory item 250B which may be stored in contact or in close proximity, such as by being stacked or nested together, with each other. For example, a first adjacent inventory item 250A and a second inventory item 250B may each comprise a disposable cup so that the disposable cup type adjacent inventory items 250A, 250B, are stored on an inventory management apparatus 51 by nesting them together as shown in FIG. 8. As another example, a first adjacent inventory item 250A and a second inventory item 250B may each comprise a disposable absorbent pad so that the absorbent pad type adjacent inventory items 250A, 250B, are stored on an inventory management apparatus 51 by stacking them together as shown in FIG. 12. As a further example, a first adjacent inventory item 250A and a second inventory item 250B may each comprise a utensil having a hanging aperture that may be hung on a rod-shaped inventory management apparatus 51 so that the utensil type adjacent inventory items 250A, 250B, are stored on an inventory management apparatus 51 by hanging them together in close proximity as shown in FIG. 10.

In some embodiments, a nesting tab 15 may be coupled to a portion of a divider 11, such as to a portion of the divider 11 that is distal to the articulation joint 12. A nesting tab 15 may be configured in any size and shape that may allow the nesting tab 15 to be inserted between two adjacent inventory items 250A, 250B, that are being stored by an inventory management apparatus 51. A nesting tab 15 may be made from or may comprise any suitable material, such as which may be used for all or portions of the divider 11. Optionally, a nesting tab 15 may be coupled to the divider 11 via an extension 16. An extension 16 may comprise a structure that may couple, and preferably movably couple, a nesting tab 15 to the divider 11 so that the nesting tab 15 is a desired distance away from the divider 11. Similar to a nesting tab 15, an extension 16 may be configured in any size and shape and may be made from any suitable material. Optionally, an extension 16 may comprise one or more extension hinges 17. Preferably, a first extension hinge 17 may movably couple an extension 16 to the divider 11, and a second extension hinge 17 may movably couple an extension 16 to a nesting tab 15. An extension hinge 17 may comprise any movable coupling, such as which may be used for an articulation joint 12.

FIGS. 8 and 9 illustrate still another example of a device 100. The device 100 may comprise an inventory management apparatus 51 or the device 100 may be coupled to an inventory management apparatus 51. In this example, the inventory management apparatus 51 comprises a first support surface 52 that the divider 11 is movably coupled to via a hinge type articulation joint 12. Inventory items 250, such as adjacent inventory items 250A, 250B, may be placed on the first support surface 52. The divider 11 may include a nesting tab 15 with an extension 16 coupling the divider 11 to the nesting tab 15. The nesting tab 15 may be inserted or positioned between two adjacent inventory items 250A, 250B, so that the nesting tab 15 must be moved away from the second adjacent inventory item 250B in order to remove the second adjacent inventory item 250B by moving the divider 11 into the second position 92 as shown in FIG. 9 to allow a user 200 to manipulate the second adjacent inventory item 250B. When the divider 11 is in the first position 91 (FIG. 8), the divider 11 may generally prevent the user 200 from manipulating the second adjacent inventory item 250B. By moving the divider 11 into the second position 92 (FIG. 9), access to the second storage area 82 and the inventory items 250 contained therein may be granted. In this example, the actuation sensor 13 comprises a tilt sensor 13A that generates an electronic signal 95 when the divider 11 is moved or placed in the second position 92.

FIGS. 10 and 11 illustrate still a further example of a device 100. The device 100 may comprise an inventory management apparatus 51 or the device 100 may be coupled to an inventory management apparatus 51. In this example, the inventory management apparatus 51 comprises a rod having a cylindrical shaped or rod-shaped first support surface 52, and the divider 11 may be movably coupled to another portion of the inventory management apparatus 51 via a living hinge type articulation joint 12. Inventory items 250, such as adjacent inventory items 250A, 250B, may be placed on the first support surface 52 by hanging or inserting the cylindrical shaped first support surface 52 through a hanging aperture 251 of the inventory items 250. The divider 11 may include a nesting tab 15 which may be inserted or positioned between two adjacent inventory items 250A, 250B, so that the nesting tab 15 must be moved away from the second adjacent inventory item 250B in order to remove the second adjacent inventory item 250B by moving the divider 11 into the second position 92 as shown in FIG. 11 to allow a user 200 to manipulate the second adjacent inventory item 250B. Optionally, a divider 11 may comprise a divider aperture 18 which may be shaped to extend around portions of an inventory management apparatus 51. When the divider 11 is in the first position 91 (FIG. 10), the divider 11, via the nesting tab 15, may generally prevent the user 200 from manipulating the second adjacent inventory item 250B. By moving the divider 11 into the second position 92 (FIG. 11), access to the second storage area 82 and the inventory items 250 contained therein may be granted. In this example, the actuation sensor 13 comprises a hall effect sensor 13B that generates an electronic signal 95 when it is moved away from a magnet 13C as the divider 11 is moved or placed in the second position 92. Preferably, the magnet 13C may be coupled to the divider 11 proximate to the divider aperture 18.

FIG. 12 depicts still a further example of a device 100. The device 100 may comprise an inventory management apparatus 51 or the device 100 may be coupled to an inventory management apparatus 51. In this example, the inventory management apparatus 51 comprises a first support surface 52 that the divider 11 is movably coupled to via a hinge type articulation joint 12. Inventory items 250, such as adjacent inventory items 250A, 250B, may be placed on the first support surface 52. The divider 11 may include a nesting tab 15, and the nesting tab 15 may be inserted or positioned between two adjacent inventory items 250A, 250B, so that the nesting tab 15 must be moved away from the second adjacent inventory item 250B in order to remove the second adjacent inventory item 250B by moving the divider 11 out of the first position 91 and into the second position 92 to allow a user 200 to manipulate the second adjacent inventory item 250B. When the divider 11 is in the first position 91 as shown in FIG. 12, the divider 11, via the nesting tab 15, may generally prevent a user 200 from manipulating the second adjacent inventory item 250B. By moving the divider 11 into the second position 92, access to the second storage area 82 and the inventory items 250 contained therein may be granted. In this example, the actuation sensor 13 comprises a tilt sensor 13A that generates an electronic signal 95 when the divider 11 is moved or placed in the second position 92.

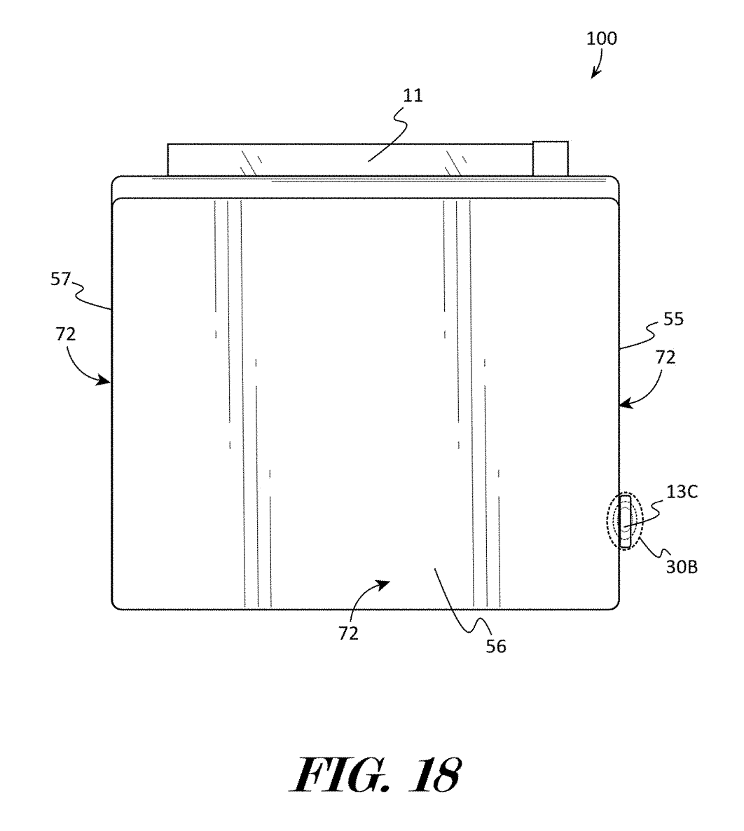

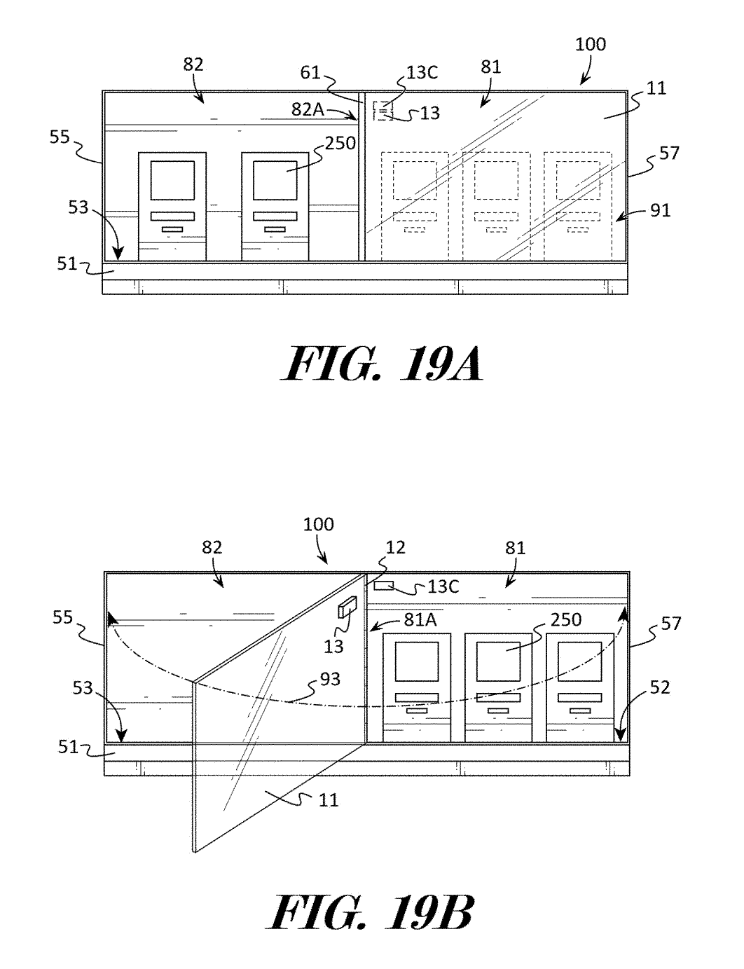

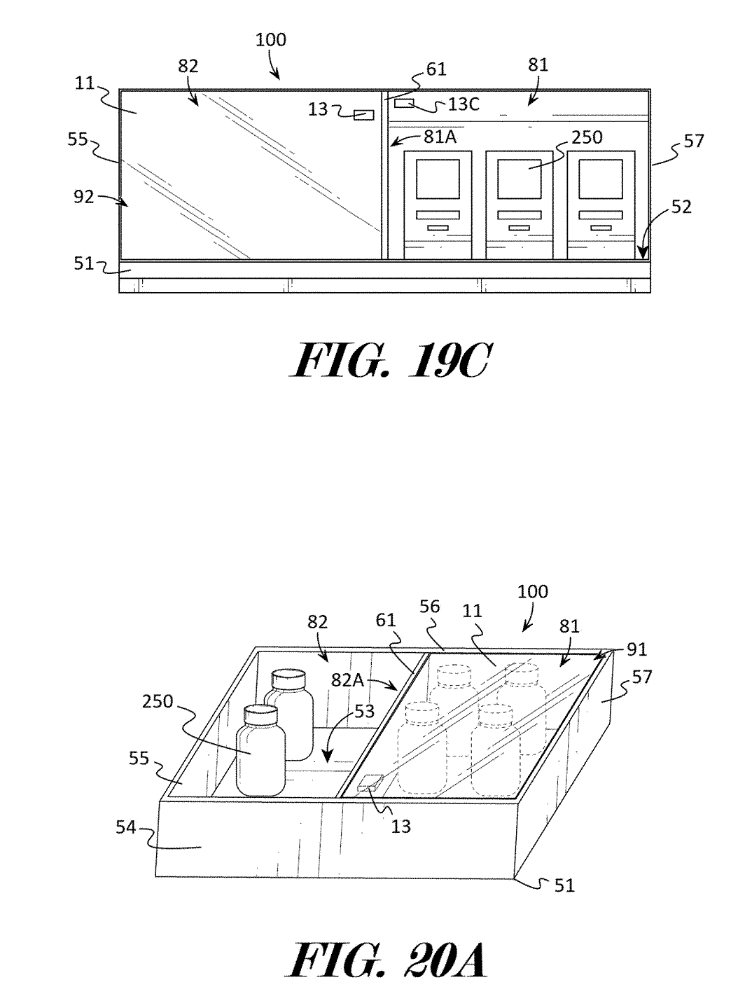

FIGS. 19A-21B depict further examples of a device 100. In some embodiments, the device 100 may comprise a barrier wall 61 positioned between a first storage area 81 of an inventory management apparatus 51 and a second storage area 81 of the inventory management apparatus 51. In other embodiments, the device 100 may be coupled to the barrier wall 61 of an inventory management apparatus 51 in which the barrier wall 61 may be positioned between a first storage area 81 of an inventory management apparatus 51 and a second storage area 82 of the inventory management apparatus 51.

Generally, a barrier wall 61 may comprise a partition which may separate two or more storage areas 81, 82, of an inventory management apparatus 51 so that inventory items 250 must be moved over or around the barrier wall 61 in order to be moved from a first storage area 81 positioned on the first side 81A of the barrier wall 61 to a second storage area 82 positioned on the second side 82A of the barrier wall 61 (inventory items 250 in the first storage area 81 may be considered to be on the first side 81A of the barrier wall 61 and inventory items 250 in the second storage area 82 may be considered to be on the second side 82A of the barrier wall 61). In some embodiments, a barrier wall 61 may be integrally formed with an inventory management apparatus 51, while in other embodiments, a barrier wall 61 may be coupled to portions of an inventory management apparatus 51 with one or more fasteners, adhesive, or any other coupling method.

Generally, an articulation joint 12 may be configured to enable a divider 11 to be moved between a first position 91 and a second position 92. In preferred embodiments, an articulation joint 12 may be coupled to the barrier wall 61, and a divider 11 may be coupled to the articulation joint 12 so that the articulation joint 12 may movably couple the divider 11 to the barrier wall 61. In further preferred embodiments, an articulation joint 12 may pivotally couple a divider 11 to the barrier wall 61. Optionally, a divider 11 may be movably coupled to the inventory management apparatus 51 via an articulation joint 12 without a barrier wall 61 and/or without the articulation joint 12 being coupled to a barrier wall 61.

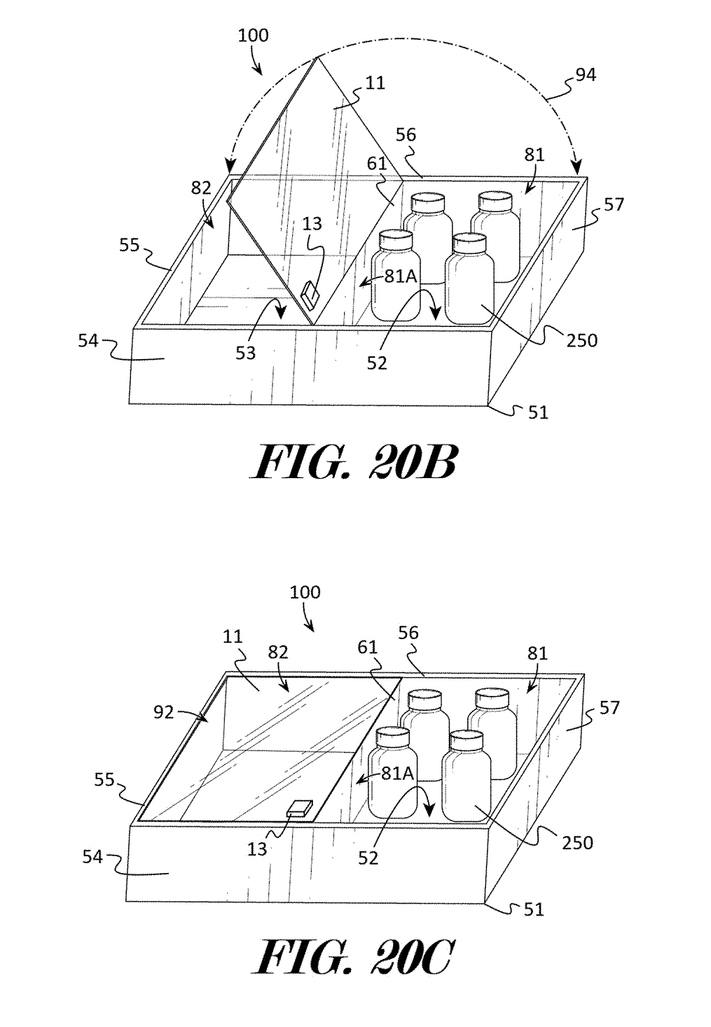

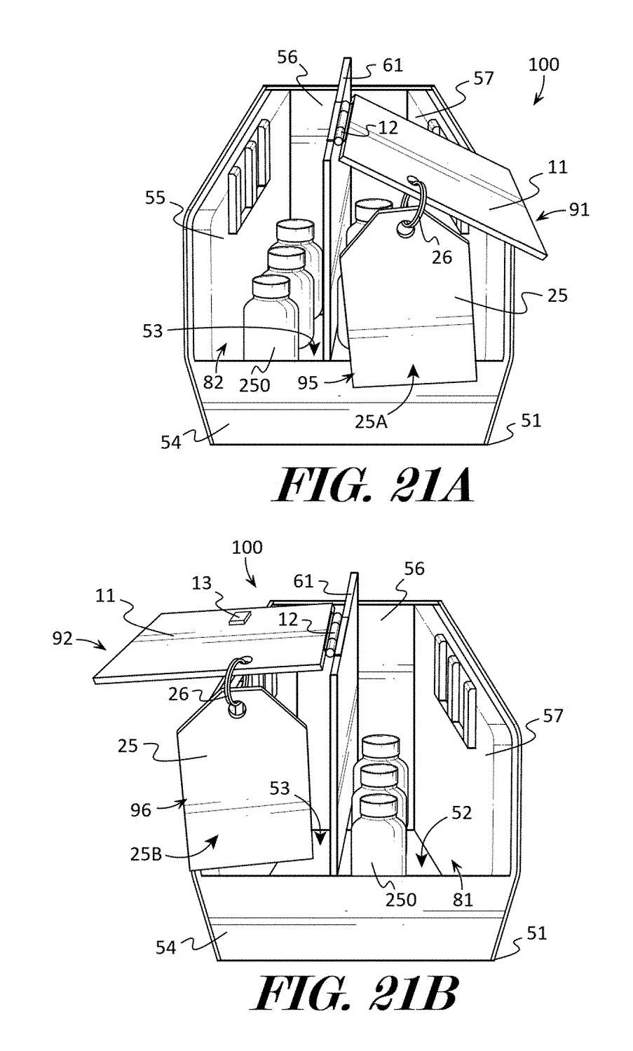

In some embodiments, a divider 11 may block access to a first storage area 81 and a first quantity of inventory items 250 that may be contained in the first storage area 81 when the divider 11 is in the first position 91, and the divider 11 may block access to a second storage area 81 and a second quantity of inventory items 250 that may be contained in the second storage area 82 when the divider 11 is in the second position 92. As illustrated in FIGS. 19A-19C, in some embodiments, a divider 11 may generally be moved horizontally (horizontal movement 93) between the first position 91 and the second position 92. As depicted in FIGS. 20A-21B, in some embodiments, a divider 11 may generally be moved vertically (vertical movement 94) between the first position 91 and the second position 92.

As perhaps best shown in FIGS. 21A and 21B, in some embodiments, the device 100 may comprise an auxiliary divider 25 that may be movably coupled to the divider 11 via an auxiliary fastener 26. Similar to a divider 11, an auxiliary divider 25 may be configured to govern the ability of a user 200 to access one or more inventory items 250 which may be positioned behind the auxiliary divider 25 (so that the inventory items 250 and the user 200 are positioned on opposing sides of the auxiliary divider 25. In the examples, of FIGS. 21A and 21B the inventory management apparatus 51 includes a first storage area 81 and a second storage area 82 into which a user 200 may reach in the inventory management apparatus 51 in order to add and remove inventory items 250, and the auxiliary divider 25 may block user access to portions of the first storage area 81 (FIG. 21A) or second storage area 82 (FIG. 21B) depending on which position 91, 92, that the divider 11 that the auxiliary divider 25 is coupled to is positioned in. For example, when the divider 11 is in a first position 91, the auxiliary divider 25 may be positioned proximate to the first storage area 81 so that both the divider 11 and auxiliary divider 25 may block access to inventory items 250 contained in the first storage area 81 (preferably with the auxiliary divider 25 being suspended from the divider 11 via the auxiliary fastener 26 so that the auxiliary divider 25 may block access by blocking user access to portions of the first storage area 81 relatively closer to a user 200). When the divider 11 is in a second position 92, the auxiliary divider 25 may be positioned proximate to the second storage area 82 so that both the divider 11 and auxiliary divider 25 may block access to inventory items 250 contained in the second storage area 82 (preferably with the auxiliary divider 25 being suspended from the divider 11 via the auxiliary fastener 26 so that the auxiliary divider 25 may block access by blocking user access to portions of the second storage area 82 relatively closer to a user 200).

Similar to a divider 11, an auxiliary divider 25 may be configured in any size and shape. In some embodiments, an auxiliary divider 25 may comprise one or more sides, such as a first side 25A and a second side 25B. Additionally, an auxiliary divider 25 may be movable between a first orientation 95 and a second orientation 96. In further embodiments, a first side 25A and a second side 25B may be opposingly positioned (or otherwise oriented relative to each other) on the auxiliary divider 25 so that only one side 25A, 25B, may be visible to a user 200 when the auxiliary divider 25 is in a first orientation 95 or a second orientation 96. In preferred embodiments, an auxiliary divider 25 may be movable between a first orientation 95 and a second orientation 96 in which the first side 25A may face away from the inventory management apparatus 51 when the auxiliary divider 25 is in the first orientation 95 and the second side 25B faces away from the inventory management apparatus 51 when the auxiliary divider 25 is in the second orientation 96. In further preferred embodiments, an auxiliary divider 25 may move between the first orientation 95 and the second orientation 96 when the auxiliary divider 25 is moved from the first position 91 to the second position 92. In still further embodiments, the first side 25A of the auxiliary divider 25 may face away from the inventory management apparatus 51 when the auxiliary divider 25 is in the first position 91, and the second side 25B of the auxiliary divider 25 may face away from the inventory management apparatus 51 when the auxiliary divider 25 is in the second position 92.

The auxiliary divider 25 may be movably coupled to a divider 11 via an auxiliary fastener 26 which may be configured to enable the auxiliary divider 25 to be moved into and out of the first orientation 95 and second orientation 96. Similar to an articulation joint 12, an auxiliary fastener 26 may comprise any type of hinge or other movable coupling device, fastener, or method. In the example of FIGS. 21A and 21B, the auxiliary fastener 26 may comprise a ring fastener which may pass though portions of both the divider 11 and auxiliary divider 25. In further preferred embodiments, the auxiliary fastener 26 may comprise any type of hinge or other movable coupling device, fastener, or method which may enable the auxiliary divider 25 to be moved into and out of the first orientation 95 and second orientation 96 without having to move the divider 11. For example, the auxiliary fastener 26 may comprise a movable coupling having two or more degrees of freedom so that the auxiliary fastener 26 may pivotally couple and rotationally couple the divider 11 and auxiliary divider 25 together. In this manner, the auxiliary divider 25 may both pivot relative to the divider 11 and also rotate relative to the divider 11 on at least two axes of movement provided by the auxiliary fastener 26.

While some exemplary shapes and sizes have been provided for elements of the device 100, it should be understood to one of ordinary skill in the art that the divider 11, articulation joint 12, actuation sensor 13, retainer 14, nesting tabs 15, extension 16, optional inventory management apparatus 51 including first support surface 52, second support surface 53, sidewalls 54, 55, 56, 57, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

While some materials have been provided, in other embodiments, elements that the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

In some embodiments, an inventory replenishment system (“the system”) 150 is provided. As perhaps best shown by FIG. 13, an illustrative example of some of the physical components which may comprise an inventory replenishment system (“the system”) 150 according to some embodiments is presented. The system 150 is configured to facilitate the transfer of data and information between one or more inventory replenishment devices 100, access points 103, client devices 400, and servers 300 over a data network 105. Each client device 400 may send data to and receive data from the data network 105 through a network connection 104 with an access point 103. A data store 308 accessible by the server 300 may contain one or more databases. The data may comprise any information a one or more users 200 may input into the system 150 including information on or describing one or more users 200, information on or describing one or more devices 100, information on or describing one or more inventory management apparatuses 51, information on or describing one or more inventory items 250, information which may be used to order or purchase inventory items 250, information which may be displayed to a user 200 on how to order or purchase inventory items 250, and any other information which may be generated by one or more users 200 from interaction with the system 150.

In this example, the system 150 comprises at least one client device 400 (but preferably more than two client devices 400) configured to be operated by one or more users 200. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

In some embodiments, the system 150 may be configured to facilitate the communication of information to and from one or more users 200, through their respective client devices 400, and servers 300 of the system 150. Users 200 of the system 150 may include one or more individuals that may use or stock inventory items 250 on an inventory management apparatus 51, including individuals that are involved with purchasing and auditing inventory items 250. In preferred embodiments, an actuation sensor 13 may be in communication with a client device 400 so that the electronic signal 95 generated by the actuation sensor 13 when the divider 11 is moved into the second position 92 may be communicated to the client device 400. In further preferred embodiments, the client device 400 may be in communication with one or more servers 300.

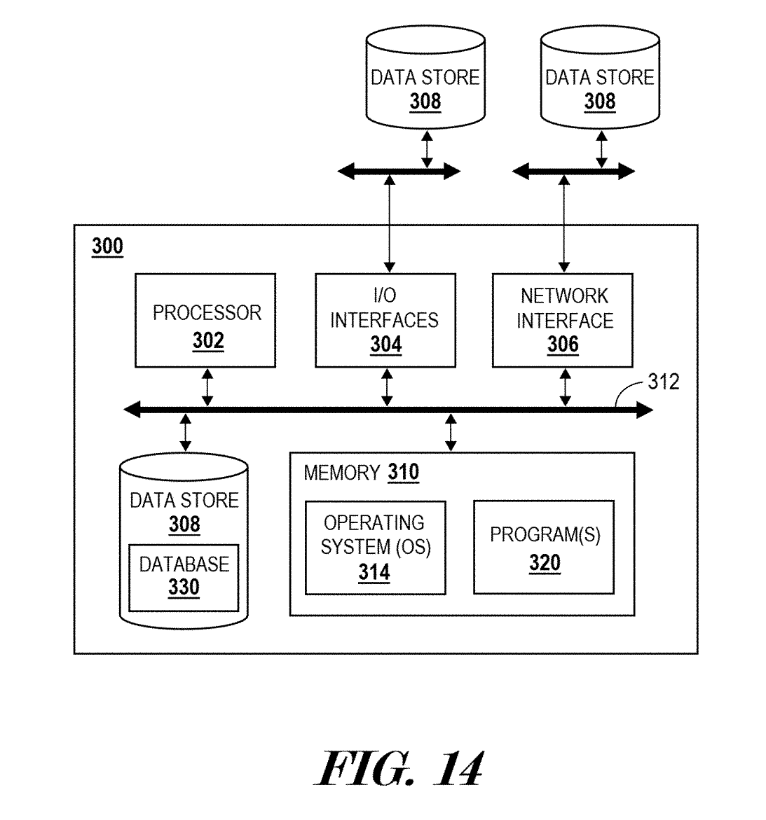

Referring now to FIG. 14, in an exemplary embodiment, a block diagram illustrates a server 300 of which one or more may be used in the system 150 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 14 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

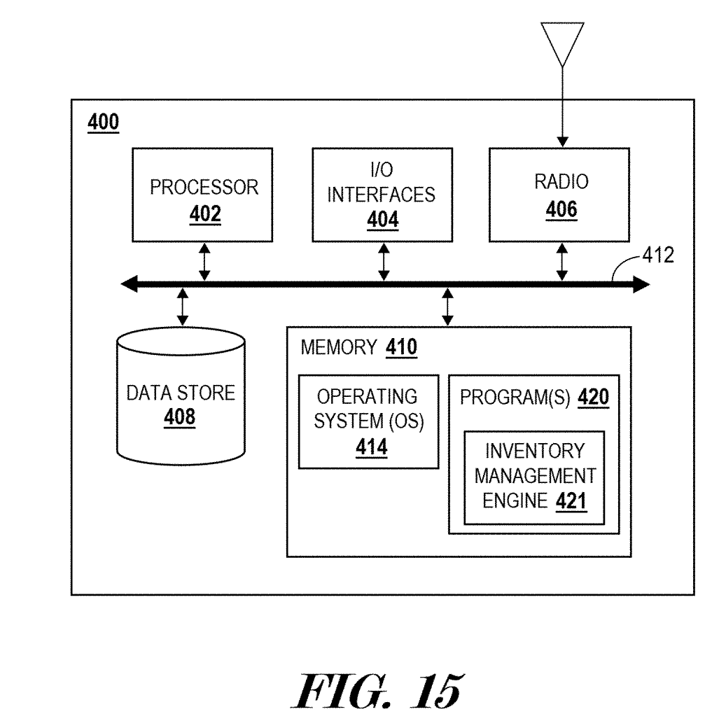

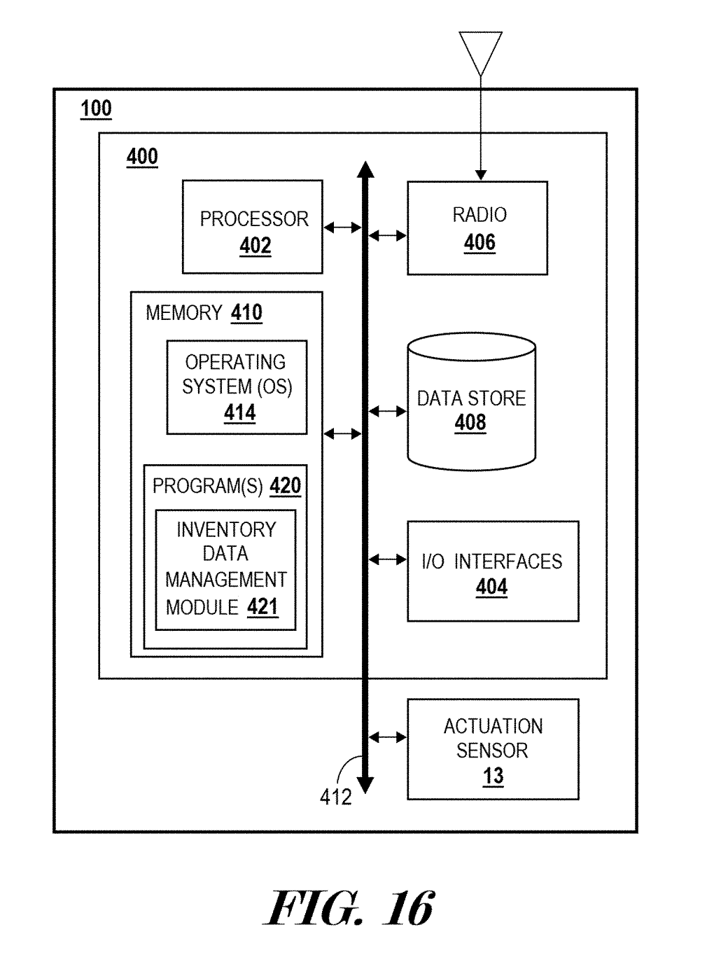

Referring to FIGS. 15 and 16, in an exemplary embodiment, a block diagram illustrates a client device 400 of which one or more may be used in the system 150 or the like and which may be a type of computing platform. In some embodiments, and as shown in FIGS. 13 and 15, an inventory replenishment device 100 may be separate from, but in communication with, a client device 400. In alternative embodiments, and as shown in FIGS. 13 and 16, an inventory replenishment device 100 may comprise a client device 400.

A client device 400 can be a digital device that, in terms of hardware architecture, generally includes a processor 402, input/output (I/O) interfaces 404, a radio 406, a data store 408, and memory 410. It should be appreciated by those of ordinary skill in the art that FIGS. 15 and 16 depict the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIGS. 15 and 16, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 150.

In preferred embodiments, a program 420 of a client device may include an inventory data management module 421 which may be configured to implement the various processes, algorithms, methods, techniques, etc. described herein. In alternative embodiments, an inventory data management module 421 may be configured as a program 320 of a server 300. An inventory data management module 421 may comprise or function as management logic stored in a memory 310, 410 which may be executable by the processor 302, 402, of a client device 400 and/or server 300. In some embodiments, an inventory data management module 421 may be configured to generate a replenishment order one or more inventory items 250 in response to receiving an electronic signal from an actuation sensor 13. In further embodiments, an inventory data management module 421 may be configured to communicate a replenishment order to a server 300.

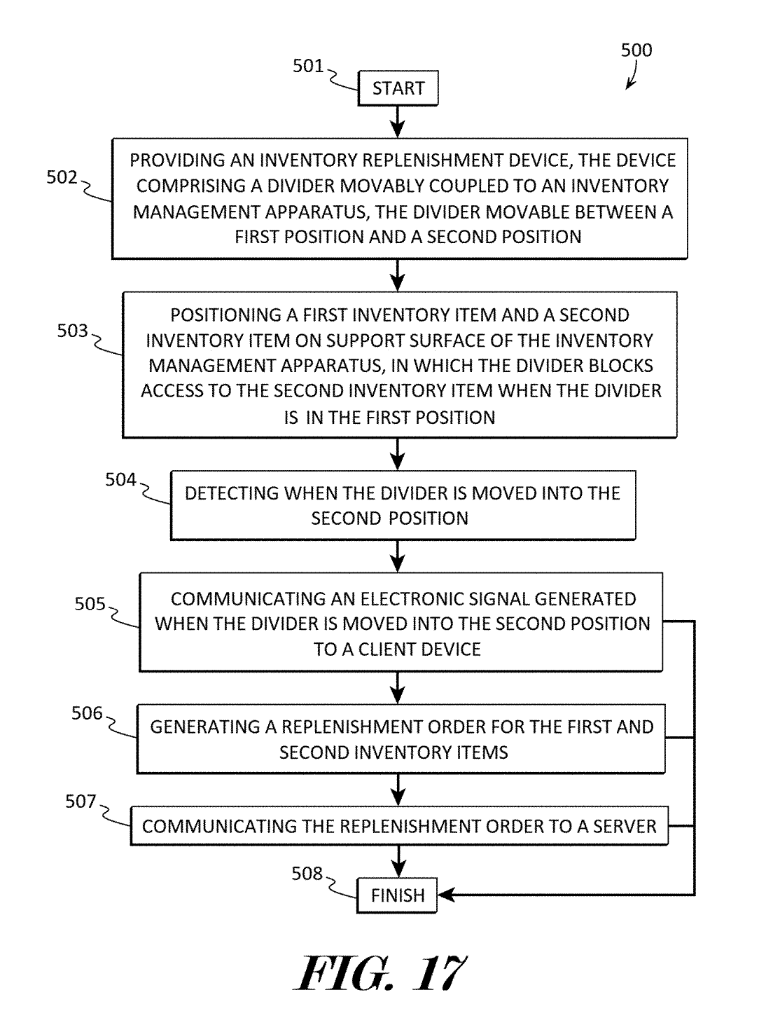

FIG. 17 shows a block diagram of an example of a computer-implemented inventory replenishment method (“the method”) 500 according to various embodiments described herein. In some embodiments, the method 500 may be used to enable the device 100 to be able to communicate to one or more client devices 400 and/servers 300 that a divider 11 has been moved to a second position 92 for an inventory management apparatus 51.

In some embodiments, the method 500 may start 501 and an inventory replenishment device 51 may be provided in step 502. In preferred embodiments, the device 100 may comprise a divider 11 which may be movably coupled to an inventory management apparatus 51, and the divider 11 may be movable between a first position 91 and a second position 92. The device 100 may also comprise an actuation sensor 13 which may be configured to detect when the divider 11 is moved into the second position 92 and configured to output an electronic signal 95 when the divider 11 is moved into the second position 92. In further embodiments, the actuation sensor 13 may be mounted onto the divider 11 and may be operable to detect movement of the divider 11 without a positional reference external to the actuation sensor 13, and the actuation sensor 13 may broadcast an electronic signal 95 upon detecting movement of the divider 11.

In step 503, a first inventory item 250A and a second inventory item 250B may be positioned on opposite sides of the divider 11 on support surfaces 52, 53, of the inventory management apparatus 51, in which the divider 11 blocks access to the second inventory item 250 when the divider 11 is in the first position 91. In further embodiments, the first inventory item 250A and the second inventory item 250B may be positioned on opposite sides of the divider 11.

In step 504, the device 100 may detect when the divider 11 is moved into the second position 92. In preferred embodiments, the actuation sensor 13 may detect when the divider 11 is moved into the second position 92.

In step 505, the device 100 may communicate an electronic signal 95 generated when the divider 11 is moved into the second position 92 to a client device 400. In preferred embodiments, an electronic signal 95 may comprise a radio frequency (RF) electronic signal. Optionally, the device 100 may comprise a client device 400 or the device 400 may be separate from the device 100. In preferred embodiments, an actuation sensor 13 may output a wireless electronic signal 95 (such as a radio frequency (RF) electronic signal) or a wired electronic signal 95 to the client device 400 when the divider 11 is moved into the second position 92. Preferably, the actuation sensor 13 may be configured to communicate the electronic signal 95 (the electronic signal 95 being or comprising a restocking request) to an inventory data management module 421 comprising a user interface, the inventory data management module 421 facilitating the administration of the inventory item 250 (such as the reordering or restocking request of the inventory item 250). In some embodiments, after step 505 the method 500 may finish 508.

In further embodiments, the method 500 may continue to step 506 in which a replenishment order may be generated for the first 250A and second 250B inventory items. In preferred embodiments, a replenishment order may be generated via an inventory data management module 421 of a client device 400 or a server 300 that is in communication with the device 100. A replenishment order may comprise information which may be used by a user 200, a client device 400, and/or a server 300 that may be used for the purchase or ordering of inventory items 250. For example, a replenishment order may comprise a purchase order that may have information describing a desired quantity of inventory items 250, purchase and shipping price for the inventory items 250, vendor contact information, and shipping and delivery information. In some embodiments, after step 506 the method 500 may finish 508.

In further embodiments, the method 500 may continue to step 506 in which the replenishment order may be communicated to a server 300 by the client device 400. By communicating the replenishment order that may be used for the purchase or ordering of inventory items 250 to a server 300, the replenishment order may be communicated to a user 200, a client device 400, and/or a server 300 that may complete the purchase, ordering, or delivery of inventory items 250. In some embodiments, after step 507 the method 500 may finish 508.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An inventory replenishment device, the device comprising:
a. a barrier wall positioned between a first support surface of an inventory management apparatus and a second support surface of the inventory management apparatus, the barrier wall forming a barrier between the first support surface and the second support surface, the inventory management apparatus adapted to hold a plurality of inventory items segregated into a first quantity of inventory items supported on the first support surface and being located on a first side of the barrier wall and a second quantity of inventory items supported on the second support surface and being located on an opposing second side of the barrier wall;
b. an articulation joint coupled to the barrier wall;
c. a divider coupled to the articulation joint, wherein the articulation joint is configured to enable the divider to be moved between a first position and a second position, the divider blocking access to the first quantity of inventory items when the divider is in the first position, and the divider blocking access to the second quantity of inventory items when the divider is in the second position; and
d. an actuation sensor configured to detect when the divider is moved between the first position and the second position and further configured to output an electronic signal when the divider is moved between the first position and the second position.

2. The device of claim 1, wherein the actuation sensor is a tilt sensor and the tilt sensor is configured to measure an angle of the divider relative to the first support surface of the inventory management apparatus.

3. The device of claim 1, wherein the actuation sensor is a hall effect sensor configured to detect a magnetic field from a magnet, the magnet spaced laterally apart from the divider and positioned external to a base of the divider.

4. The device of claim 1, wherein the actuation sensor outputs a radio frequency (RF) electronic signal.

5. The device of claim 1, further comprising an auxiliary divider that is movably coupled to the divider.

6. The device of claim 7, wherein the auxiliary divider comprises a first side and a second side, the auxiliary divider movable between a first orientation and a second orientation, wherein the first side faces away from the inventory management apparatus when the divider is in the first position, and wherein the second side faces away from the inventory management apparatus when the divider is in the second position.

7. The device of claim 1, further comprising a client device in communication with the actuation sensor.

8. The device of claim 1, wherein the divider is moved horizontally between the first position and the second position.

9. The device of claim 1, wherein the divider is moved vertically between the first position and the second position.

10. The device of claim 1, wherein the electronic signal is a restocking request that is transmitted to an inventory data management module.

11. An inventory replenishment device, the device comprising:
a. an articulation joint coupled to an inventory management apparatus, the inventory management apparatus having a first storage area for containing a first quantity of inventory items and a second storage area for containing a second quantity of inventory items;
b. a divider coupled to the articulation joint, wherein the articulation joint is configured to enable the divider to be moved between a first position and a second position, the divider blocking access to the first storage area when the divider is in the first position, and the divider blocking access to the second storage area when the divider is in the second position; and
c. an actuation sensor configured to detect when the divider is moved between the first position and the second position and further configured to output an electronic signal when the divider is moved between the first position and the second position.

12. The device of claim 11, wherein the actuation sensor is a tilt sensor and the tilt sensor is configured to measure an angle of the divider relative to the first support surface of the inventory management apparatus.

13. The device of claim 11, wherein the actuation sensor is a hall effect sensor configured to detect a magnetic field from a magnet, the magnet spaced laterally apart from the divider and positioned external to a base of the divider.

14. The device of claim 11, wherein the actuation sensor outputs a radio frequency (RF) electronic signal.

15. The device of claim 11, further comprising an auxiliary divider that is movably coupled to the divider.

16. The device of claim 15, wherein the auxiliary divider comprises a first side and a second side, the auxiliary divider movable between a first orientation and a second orientation, wherein the first side faces away from the inventory management apparatus when the divider is in the first position, and wherein the second side faces away from the inventory management apparatus when the divider is in the second position.

17. The device of claim 11, further comprising a client device in communication with the actuation sensor.

18. The device of claim 11, wherein the divider is moved horizontally between the first position and the second position.

19. The device of claim 11, wherein the divider is moved vertically between the first position and the second position.

20. The device of claim 11, wherein the electronic signal is a restocking request that is transmitted to an inventory data management module.
